(19) United States
(12) Patent Application Publication
(10) Pub. No.: US 2021/0343040 A1
(43) Pub. Date: Nov. 4, 2021

(54) OBJECT TRACKING

(71) Applicant: UNIVERSITY OF NORTHUMBRIA AT NEWCASTLE, Newcastle Upon Tyne (GB)

(72) Inventor: Lars Erik Holmquist, Newcastle Upon Tyne (GB)

(73) Assignee: UNIVERSITY OF NORTHUMBRIA AT NEWCASTLE, Newcastle Upon Tyne (GB)

(21) Appl. No.: 17/271,241

(22) PCT Filed: Aug. 29, 2019
(86) PCT No.: PCT/GB2019/052411

§ 371 Date: Feb. 25, 2021

(30) Foreign Application Priority Data
Sep. 3, 2018 (GB) 1814260.4

(51) Int. Cl. G06T 7/73; G06T 11/00

(52) U.S. Cl. CPC G06T 7/74; G06T 2207/10028; G06T 2207/30204; G06T 11/00

(57) ABSTRACT

A method of tracking an object. The method comprises imaging a marker on an object surface using a depth imaging camera, said marker comprising a three-dimensional pattern; generating a representation of the marker; matching the representation of the marker to a representation of a reference three-dimensional pattern in a reference orientation; comparing the representation of the marker to the representation of the reference three-dimensional pattern, and thereby determining a position and orientation of the object relative to the camera.

### TECHNICAL FIELD

The present invention relates to methods and devices for tracking objects.

### BACKGROUND

Techniques for object tracking are well known and widely used. For example, in virtual reality applications and augmented reality applications, object tracking techniques are used to convert the position and orientation of real-world objects into information which is used to generate and display graphical elements on a display device (for example a display screen of a device such as a smartphone or a virtual reality headset).

For example, the position of a game controller operated by a user may be used to generate a graphical element on a virtual reality headset corresponding to a sword. The graphical element is displayed in such a way that a sword appears to be moving in correspondence with movement of the game controller as the user changes the position and orientation of the controller.

In another example, object tracking is used to insert graphical elements into images of a scene captured by a camera that is displayed on a display screen. The graphical elements are displayed in such a way that it appears, when viewed on a screen, that the graphical elements are actually present in the scene, for example, as the position of the camera is moved, the aspect of the graphical element is changed to make it appear stationary relative to the camera. For example, a user may use a smartphone to capture video images of a room. An object tracking process running on the smartphone can be used to determine the position of the walls, floor and ceiling of the room relative to the smartphone and generate a graphical element corresponding to an item of furniture, for example a representation of a sofa and display this graphical element on a display of the smartphone. In this way, a user can get a sense of what a sofa would look like if it were actually present in the room by panning the smartphone around an area of the room they intend to place a sofa whilst viewing the display in which the sofa graphical element has been inserted. In order to display the correct aspect of the representation of the sofa, the object tracking process tracks the position of the smartphone relative to the objects within the room (walls, floor ceiling etc).

In both examples described above, objects must be tracked, that is the position and orientation of objects must be determined.

For tracking the position of walls, floors and ceilings etc, image processing can be performed on images captured by a device whilst the device is moved in a predetermined manner (tracked, for example, using sensors such as accelerometers typically fitted to smartphones). The image processing attempts to identify parts of the image corresponding to floors, walls, ceilings etc (for example identifying artefacts such as horizontal and vertical edges) and estimate from this the actual position of these objects by analysing how the appearance of these artefacts change as the field of view of the camera changes in known ways. Similar techniques are known for recognising specific objects that have distinctive shapes, or other characteristics, that can be identified from images of the object.

For tracking the position of objects such as games controllers, markers (e.g. two-dimensional patterns that be readily detected in images captured by a camera) can be fixed to the object surface. Movement of the image capturing device is then compared to changes in the appearance of the marker in the captured images to determine the location of the object on which the marker is present. To improve accuracy, two or more cameras separated by a known distance can be used. To improve accuracy further, two or more markers can be used, again separated by a known distance.

Cameras providing the necessary level of image resolution and processors capable of performing the necessary image processing are widely available, therefore conventional image-processing based object tracking techniques of the type described above can be conveniently and readily implemented.

However, such image-processing based techniques are far from optimised and it is common for them to lose track of the objects resulting in the virtual reality or augmented reality application to cease to display graphical elements correctly.

Certain embodiments of the present invention aim to provide improved image-processing based object tracking techniques.

### SUMMARY OF THE INVENTION

In accordance with a first aspect of the invention, there is provided a method of tracking an object. The method comprises imaging a marker on an object surface using a depth imaging camera, said marker comprising a three-dimensional pattern; generating a representation of the marker; matching the representation of the marker to a representation of a reference three-dimensional pattern in a reference orientation; comparing the representation of the marker to the representation of the reference three-dimensional pattern, and thereby determining a position and orientation of the object relative to the camera.

Optionally, the method further comprises, generating and displaying on a display a graphical element in dependence on the determined position and orientation of the object.

Optionally, the method further comprises, generating and displaying on the display the graphical element in dependence on the determined position and orientation of the object, comprises displaying one or more of a position, size and orientation of the graphical element in dependence on the determined position and orientation of the object.

Optionally, the method further comprises, capturing images of a scene including the object with a two-dimensional camera, and displaying the images of the scene on the display.

Optionally, the method further comprises, displaying the graphical element on the display in a position corresponding to the position of the object in the scene, thereby superimposing the graphical element over the object in the image of the scene.

Optionally, the graphical element is a representation of a three-dimensional object.

Optionally, the marker is one of a plurality of markers, and the method further comprises identifying to which marker from the plurality of markers the marker on the object surface corresponds.

Optionally, each of the plurality of markers is associated with an object, and the method further comprises identifying the object based on the identification of the marker from the plurality of markers.

Optionally, the graphical element is one of plurality of graphical elements, the method further comprising, responsive to identifying which marker from the plurality of markers the marker on the object surface corresponds, selecting the graphical element from the plurality of graphical elements.

Optionally, the method further comprises imaging one or more further markers on the object surface using the depth imaging camera, said further markers comprising a three-dimensional pattern; generating a representation of each of the further markers; matching the representations of the further markers to a representation of a reference three-dimensional pattern in a reference orientation; comparing the representations of the further markers to the representation of the reference three-dimensional pattern, and thereby further determining a position and orientation of the object relative to the camera.

Optionally, the method further comprises identifying on the marker and the one or more further markers an identifying mark uniquely identifying that marker and determining a position of the marker and one or more further markers on the surface of the object based on the identifying mark on each of the marker and one or more further markers.

Optionally, the marker is a three-dimensional grid comprising grid elements, wherein one or more of the grid elements are raised grid elements.

In accordance with a second aspect of the invention, there is provided an object tracking device comprising a depth imaging camera, a processor and a memory adapted to perform a method according to the first aspect of the invention.

Optionally, object tracking device is a smartphone.

In accordance with a third aspect of the invention, there is provided a computer program which when implemented on a processor of an object tracking device controls the processor to perform a method according to the first aspect of the invention.

In accordance with embodiments of the invention, an improved technique for object tracking is providing. As described above, conventional techniques for object tracking typically involve analysing captured images to identify two dimensional markers distributed across an object or by performing image processing to identify objects within an image by recognising parts of the image that might correspond to the object being tracked (e.g. edges, distinctive shapes etc).

In accordance with aspects of the invention, it has been recognised that depth imaging cameras, increasingly included in modern consumer devices such as smartphones, can advantageously be used to track objects by detecting markers on an object surface that comprise a three-dimensional pattern.

The additional spatial information provided by a depth image captured from a depth imaging camera (compared to a conventional two-dimensional image captured by a normal two-dimensional imaging camera of a marker) means that if a captured depth image of the pattern is compared with a reference representation of the three-dimensional pattern, not only can the presence of a marker be readily identified, but also the orientation and position of the object surface relative to the camera. Use of the technique can therefore result in faster and more accurate object tracking compared to conventional techniques relying on two-dimensional object markers.

As described above, other object tracking techniques require the object being tracked to have a predetermined three-dimensional shape. Advantageously, objects tracked in accordance with the present technique can take any appropriate shape.

Further, in certain embodiments, the three-dimensional marker can be physically embeded into the object to be tracked. As a result, the marker is more resilient to a two-dimensional marker that might typically be fixed to an object as a sticker or painted on making it more likely to be damaged or obscured.

Further, in certain embodiments, as the marker is a shape, rather than a visible mark, it can be added to an object in a less prominent, more subtle fashion, making its appearance less obvious.

In accordance with certain embodiments of the invention, multiple versions of the same marker are distributed across an object surface. Advantageously, if one marker is obscured, the other unobscured markers can still be tracked therefore avoiding the object tracking process failing.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a schematic diagram of an object tracking device in accordance with certain embodiments of the invention;

FIG. 2 provides a schematic diagram of a smartphone comprising a depth imaging camera;

FIG. 3a, 3b, 3c, 3d provide schematic diagrams depicting use of a technique in accordance with certain embodiments of the invention;

FIG. 4a provides a schematic diagram depicting an association of graphical elements with markers in accordance with certain embodiments of the invention;

FIG. 4b provides a schematic diagram depicting an example object on which is marker in accordance with certain embodiments of the invention;

FIGS. 5a, 5b and 5c, provide schematic diagrams depicting use of a technique in accordance with certain embodiments of the invention;

FIG. 6 provides a schematic diagram of an object surface comprising multiple markers in accordance with certain embodiments of the invention;

FIG. 7 provides a flow chart of a method in accordance with certain embodiments of the invention, and

FIG. 8 provides a schematic diagram of an object tracking system arranged in accordance with certain embodiments of the invention.

### DETAILED DESCRIPTION

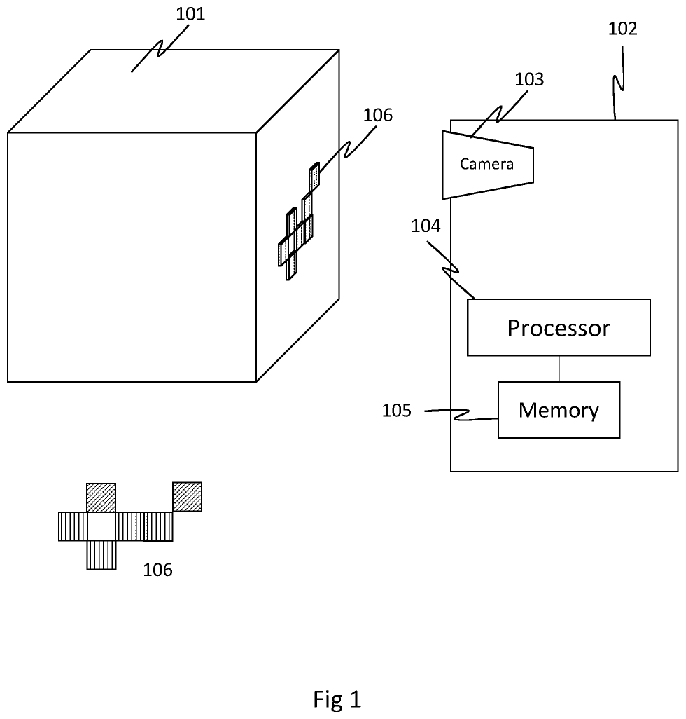

FIG. 1 provides a simplified schematic diagram of a technique in accordance with certain embodiments of the invention.

FIG. 1 shows an object 101 and an object tracking device 102 adapted to estimate the position and orientation of the object 101.

The object tracking device comprises a depth imaging camera 103, connected to a processor unit 104 and a memory unit 105 connected to the processor unit 104.

Depth imaging cameras (sometimes referred to as “depth sensing 3D cameras” or “depth sensing sensors”) are well-known in the art and any suitable depth imaging camera can be used. Examples of depth imaging cameras include the “Kinect” sensor provided as part of the Microsoft Kinect series of products, Intel “RealSense” series of depth cameras, imaging sensors provided with Google “Project Tango” devices On a surface of the object is a marker 106. The marker 106 comprises a three-dimensional pattern.

In use, the object tracking device 102 is directed at an object to be tracked, i.e. the object 101 shown in FIG. 1. The processor unit 104 controls the depth imaging camera 103 to undertake an imaging operation in which everything in the field of view of the depth imaging camera is imaged. The depth imaging camera generates a sequence of depth images which are communicated to the processor unit 104.

Typically, each depth image comprises a two-dimensional image whereby each pixel is associated with a “range value”, that is, an estimated distance from the camera. As is known in the art, this enables a three-dimensional representation of the area within the field of view of the depth imaging camera to be generated.

The processor unit 104 has running thereon depth image imaging processing software. The image processing software is arranged to recognise regions of the depth image that correspond to a three-dimensional marker.

For example, in certain embodiments, the marker comprises a grid of squares of known size (for example 3 by 5) in which a certain number of squares within the grid are elevated above the object surface a predetermined amount. The particular dimensions of the marker will depend on the resolution of the depth imaging camera and the distance the object is likely to be from the object tracking device.

A depth image taken of an object including such a marker will contain a number of characteristic features (e.g. a number of closely spaced and regularly distributed edges). The image processing software is arranged to perform a marker identification process to identify such regions from each depth image as regions of interest (if present). The processing software is then arranged to convert each region of interest into a three-dimensional representation of the region of interest.

Stored in the memory unit is a reference three-dimensional pattern which corresponds to the three-dimensional marker on the surface of the object 101. The processor is arranged to perform a comparing operation whereby the reference three-dimensional pattern is compared to the three-dimensional representation of the region of interest. The comparing operation determines if the three-dimensional representation of the region of interest matches the reference three-dimensional pattern. If it is determined that the three-dimensional representation of the region of interest does match the reference three-dimensional pattern, it is confirmed that the marker is present on the surface of the object.

The image processing software running on the processor then undertakes a position and orientation determining process to determine the position and orientation of the object relative to the depth imaging camera (and thus the object tracking device). An orientation calculating operation is performed in which the orientation of the three-dimensional representation of the marker from the region of interest of the depth image to the reference three-dimensional pattern to determine a geometric transform. This transform is then used to calculate the orientation of the marker, and thus the object, relative to the object tracking device. As mentioned above, the depth image comprises range information. This range information is used in a position calculating operation to determine a distance of the object from the object tracking device and thus the position of the object relative to the device. Finally, a data generation operation is performed in which object position and orientation data corresponding to the position and orientation of the object is generated.

The object position and orientation data can be used for any suitable purpose, for example for providing control input for gaming applications.

In certain embodiments, the object position and orientation data is used for augmented reality applications.

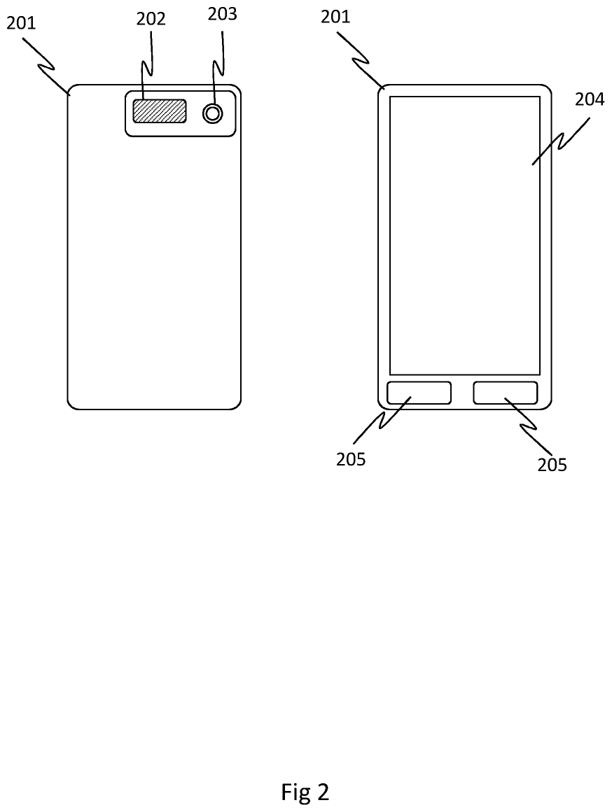

For example, in certain embodiments, the object tracking device is provided by a smartphone which includes a depth imaging camera. Simplified schematic diagrams of such a device are shown in FIG. 2.

FIG. 2 shows a first view of smartphone 201 comprising a depth imaging camera 202 and a conventional two-dimensional imaging camera 203.

Examples of smartphones equipped with depth imaging cameras include the Apple iPhone X.

FIG. 2 shows a second view of a smartphone, on the opposite side to the first view, showing a touchscreen 204 and push buttons 205. The smartphone 201 shown in FIG. 2 is otherwise a conventional smartphone and, although not shown, comprises a processor unit, memory unit, battery unit, cellular transceiver unit for sending and receiving data to and from a cellular mobile telephone network, speakers, microphones and so on.

In use, the smartphone operates in accordance with the object tracking device described above.

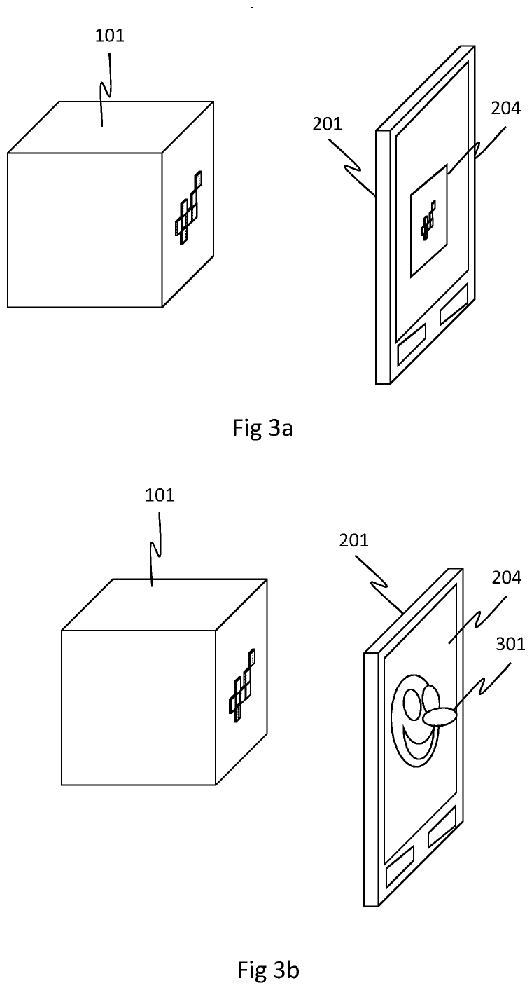

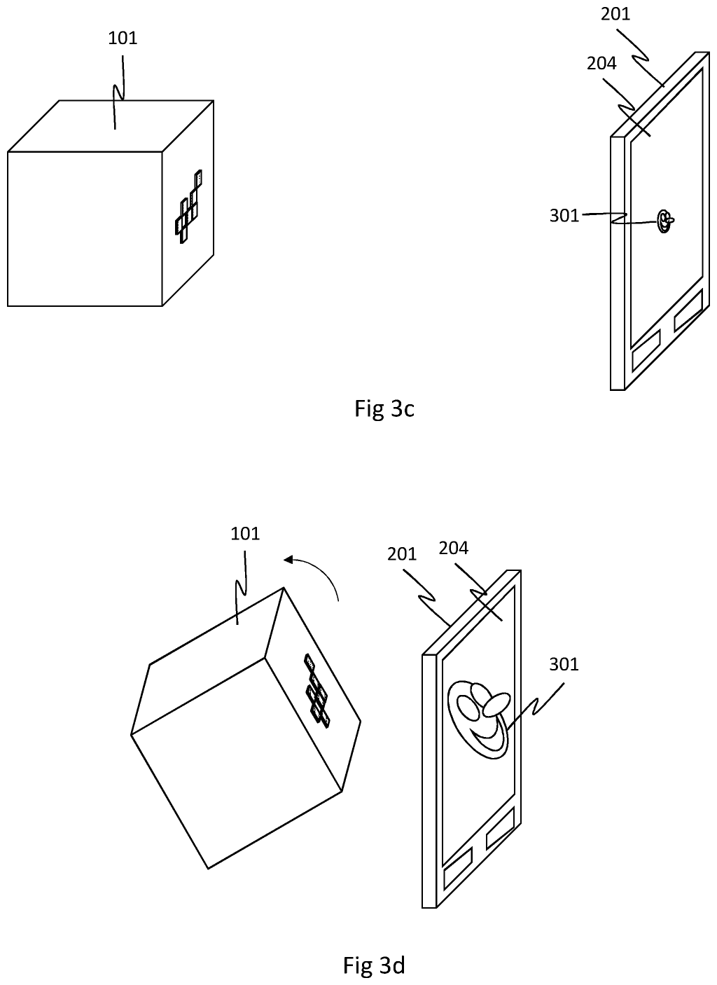

In use, a user directs the smartphone 201 at the object to be tracked. FIG. 3a provides a schematic diagram showing conventional operation in this circumstance in which software running on the processor receives image data captured from the conventional two-dimensional imaging camera and displays this on the display screen display. As can be seen, in this way the object 101 is displayed on the display screen 204 of the smartphone 201.

In accordance with certain embodiments of the invention, an augmented reality process is performed on the processor of the smartphone 201. The augmented reality process takes as input the object position and orientation data generated by the position and orientation determining process described above. The augmented reality process processes this data, in combination with information about the way the field of view of the conventional two-dimensional camera relates to what is displayed on the display screen, to generate and display a graphical element which is displayed on the display of the smartphone. The object position and orientation data is used by the augmented reality process to position and orientate the graphical element on the display screen. In certain embodiments, the graphical element is positioned so that it is superimposed over the part of the display where the object would otherwise be displayed.

FIG. 3b provides a schematic diagram showing operation of the augmented reality process on a smartphone. FIG. 3b corresponds to FIG. 3a, except as can be seen, a graphical element 301 (a smiling face) has been generated by the augmented reality process and positioned on part of display screen 204 where the image of the object would otherwise be displayed.

In accordance with certain embodiments of the invention, if the position and orientation of the object changes with respect to the smartphone 101, the display of the graphical element on the display screen of the smartphone 101.

For example, if the distance between the smartphone and the object increases, the position and orientation data generated by the position and orientation determining process changes to reflect this and the augmented reality process updates the display of the graphical element 301, for example, making it appear smaller on the display screen. FIG. 3c provides a schematic diagram depicting this.

Similarly, if the orientation of object relative to the smartphone changes, the position and orientation data generated by the position and orientation determining process changes to reflect this and the augmented reality process updates the display of the graphical element 301. For example, if the object tilts counter clockwise on one axis, the rendering of the graphical element displayed on the display screen is changed so that it appears that the graphical element has been correspondingly tilted. FIG. 3d provides a schematic diagram depicting this.

In certain embodiments, the marker is a one of a number of unique markers. The memory unit of an object tracking device stores a number of reference three-dimensional patterns, each reference three-dimensional pattern corresponding to one of the unique markers. When the processor unit performs the comparing operation, the three-dimensional representation of the region of interest is compared against all of the reference three-dimensional patterns and marker identification data is generated indicating which marker of the number of unique markers has been detected.

In certain embodiments, each unique marker is associated with a specific type of object. Information relating to each type of object associated with a unique marker may be stored in the memory of the object tracking device, for example three-dimensional shape, size, which surface of the object the marker is on, and the position of the marker on that surface. Thus, for example, with reference to FIG. 1, the marker 106 may be specifically associated with the object 101 and stored in the memory of the object tracking device is information identifying the shape (a simple cube) and dimensions of the object (e.g. 150 mm by 150 mm by 150 mm) and that the marker is positioned at a geometric centre of one of the faces of the cube.

In this way, the position, orientation and space occupied by the object relative to the object tracking device can be accurately determined at the object tracking device, simply by detecting the marker.

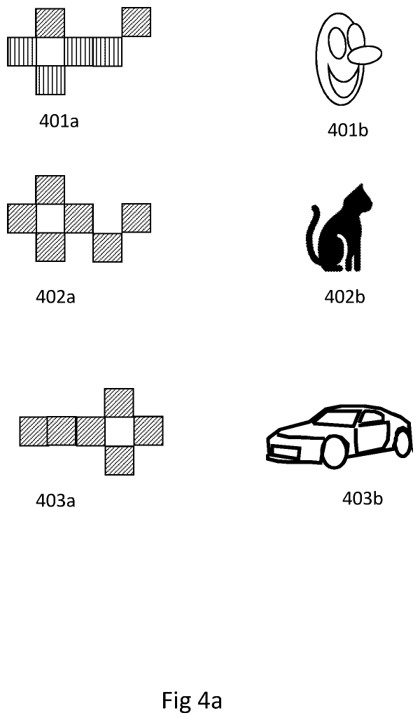

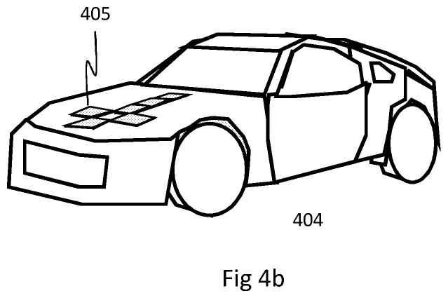

In certain embodiments, each unique marker may be associated with a particular type of graphical element. Accordingly, as described above, in the event that the marker 106 described with reference to FIG. 1 is detected, the augmented reality process running on the object tracking device such as a smartphone as described with reference to FIG. 2, generates a smiling face graphical element as shown in FIGS. 3b, 3c and 3d. However, the augmented reality process generates a different graphical element if a different marker was detected. This concept is illustrated in FIG. 4.

FIG. 4 shows a first marker 401a is associated with a graphical element which is a three-dimensional representation of a smiley face 401a as described above; a second marker 402a is associated with a graphical element which is a three-dimensional representation of a cat 402a, and a third marker 403a which is associated with a three-dimensional representation of a car 403b.

In certain embodiments, an object corresponding to a graphical element can be produced and the display of a graphical element can be used to give a user a sense of how an object might appear in the real world.

For example, a model car of a car could be manufactured, for example using three-dimensional printing techniques. The printed model car may be made of plastic which is substantially transparent. The printed model car includes on a surface a three-dimensional marker as described above. For example, the marker could correspond to the marker 403a shown in FIG. 4. When the model car is placed within the field of view of an object tracking device, the graphical element 403b is shown. The graphical element 403b can be displayed in such a way that a user can change the colour of the graphical element to get a sense of what a real-world car, corresponding to the car depicted by the graphical element would look like, from different angles, in different colours.

An example of such an arrangement is depicted in FIG. 4b. FIG. 4b provides a schematic diagram of a model car 404 as described above which includes a three-dimensional marker 405 positioned on the surface of the model car 404.

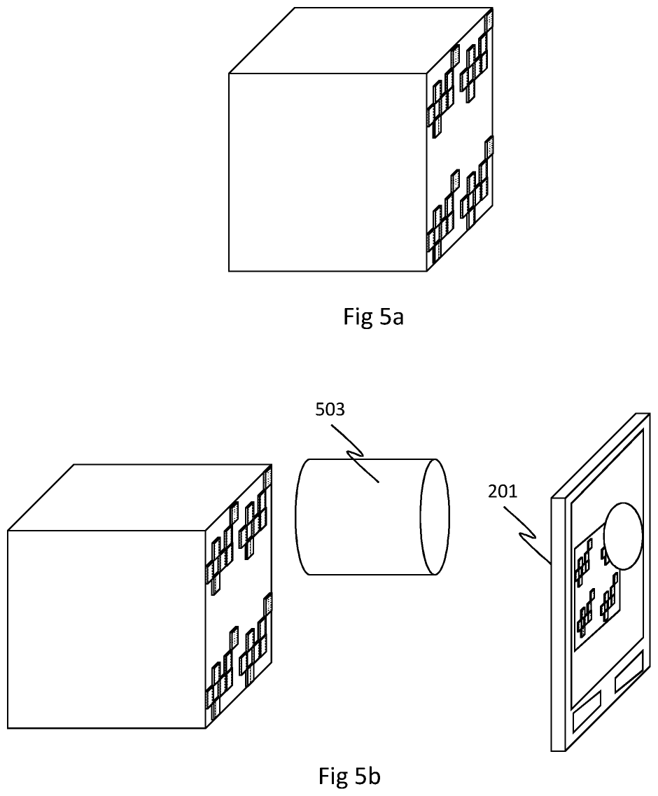

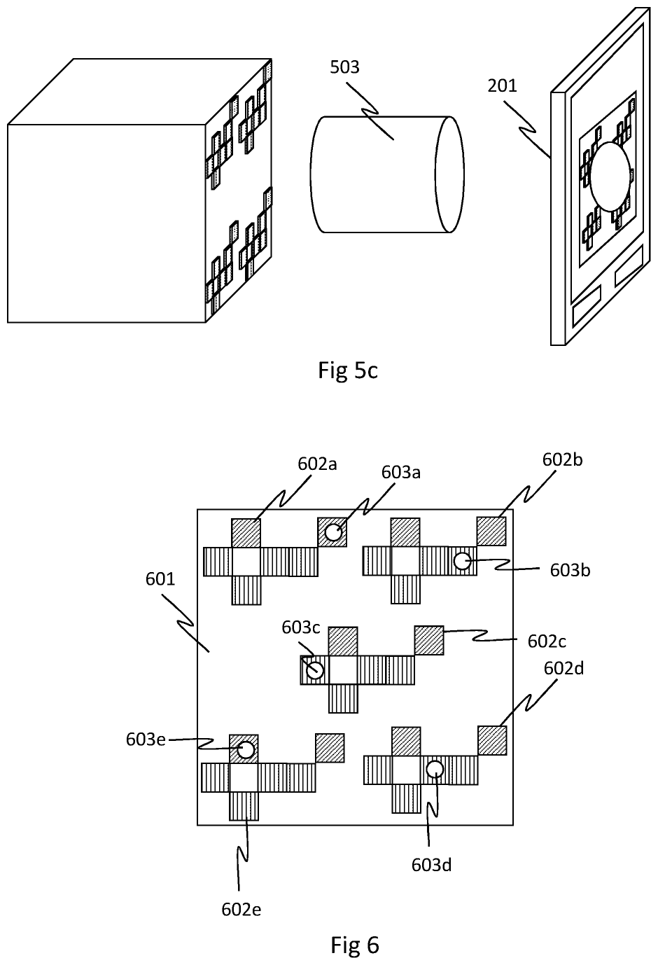

In accordance with certain embodiments, an object to be tracked is provided with multiple markers. An example of this is shown in FIG. 5a. FIG. 5a depicts an object 501 which corresponds to the object 101 described with reference to FIG. 1 except that the surface comprises multiple “copies” of the marker 502a, 502b, 502c, 502d. Advantageously, in the event that one marker is obscured, for example by another object 503, as shown in FIG. 5b, the marker identification process described above, can still identify at least one region of interest from one of the other markers, and the position and orientation determining process can be undertaken as described above.

In certain situations, all of the markers on an object surface may be partially obscured as depicted, for example, in FIG. 5c. To address this, in certain embodiments, the marker identification process is arranged to detect multiple regions of interest corresponding to each partially obscured marker and perform a stitching process to “stitch” together a composite of the marker and from this composite of the marker generate a three-dimensional representation of the composite marker to use in the comparison process in which the three-dimensional representation of the composite marker is compared with the reference three-dimensional pattern. This stitching process can be undertaken by a stitching process which is arranged to recognise parts of the markers and determine where within the reference representation of the three-dimensional pattern these parts may fit.

In certain embodiments in which multiple versions of a marker are distributed over a surface of an object, each version of the marker is modified by a modifier mark. The modifier mark is a modification to each marker that allows it to be uniquely identified. Advantageously, this allows a markers position in an object surface to be determined, and therefore the position and orientation of the object to be determined, with an improved level of accuracy.

A schematic diagram depicting this concept is shown in FIG. 6.

FIG. 6 provides a schematic diagram showing a surface 601 of an object corresponding to the object (i.e. a cube) shown in FIG. 1. Five markers 602a, 602b, 602c, 602d, and 602e, are distributed across the surface 601 of the object: a marker in each corner and a marker in the centre of the surface 601. Each marker 602a, 602b, 602c, 602d, and 602e corresponds with the marker described with reference to FIG. 1, i.e. a grid of squares in which a certain number of squares within the grid are elevated above the object surface a predetermined amount. However, each marker is provided with a modifier mark, specifically a circular indent 603a, 603b, 603c, 603d, and 603e, that is, one of the elevated squares in each marker includes a circular shaped indent. As can be seen from FIG. 6, the indent of each marker is positioned in a different place to the indents of the other markers.

In certain embodiments, the three-dimensional reference patterns corresponding to each marker include representations of markers with the modifier markers along with information indicating where on the surface of an object each marker is, based on the position of the marker's modifier mark. In this way, the position of orientation of an object can be determined with a greater level of accuracy.

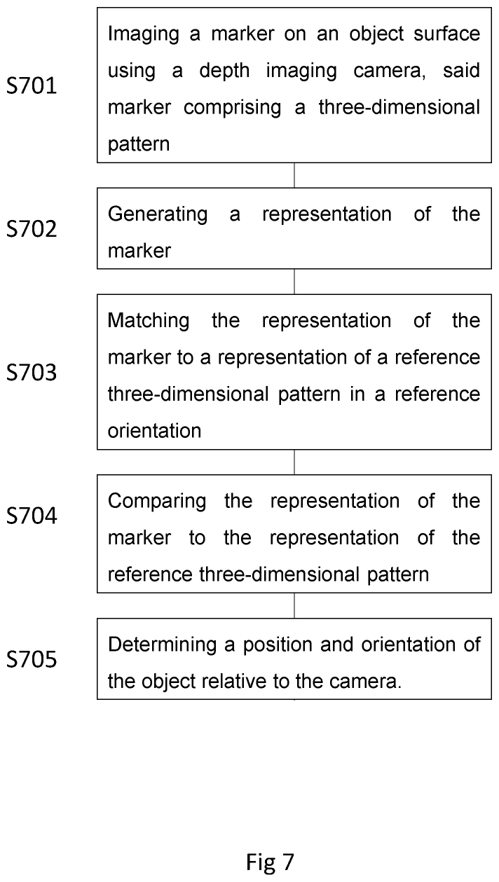

In accordance with certain embodiments of the invention, a method of tracking an object is provided. A flow chart depicting this method is shown in FIG. 7. A first step S701 comprises imaging a marker on an object surface using a depth imaging camera, said marker comprising a three-dimensional pattern; a second step S702 comprises generating a representation of the marker; a third step S703 comprises matching the representation of the marker to a representation of a reference three-dimensional pattern in a reference orientation; a fourth step S704 comprises comparing the representation of the marker to the representation of the reference three-dimensional pattern, and a fifth step S705 comprises determining a position and orientation of the object relative to the camera. In accordance with certain embodiments of the invention, such a process is provided by virtue of a computer program comprising computer implementable instructions which when executed on a suitable processor, control the processor to perform the process. Such a computer program can be provided on a any suitable computer program product such as a CD-ROM or solid-state memory storage device such as a flash storage device comprising flash storage.

The techniques described above are typically implemented by a processor implementing a computer program stored on the memory of an object tracking device. In certain embodiments described above, the object tracking device has been described in terms of a smartphone which comprises a depth sensing camera, a conventional two-dimensional camera and a processor and display. In this way, the components necessary to generate object tracking data and perform an augmented reality process as described above are integrated into a single device.

Techniques in accordance with embodiments of the invention can be implemented in any suitable device or system comprising one or more depth imaging cameras, including for example suitably equipped games consoles, personal computers, tablet computers, smart devices such as smart televisions and so on.

In other embodiments, components necessary for performing object tracking techniques in accordance with certain embodiments of the invention may be distributed across several discrete devices (rather than integrated in a single device such as a smartphone).

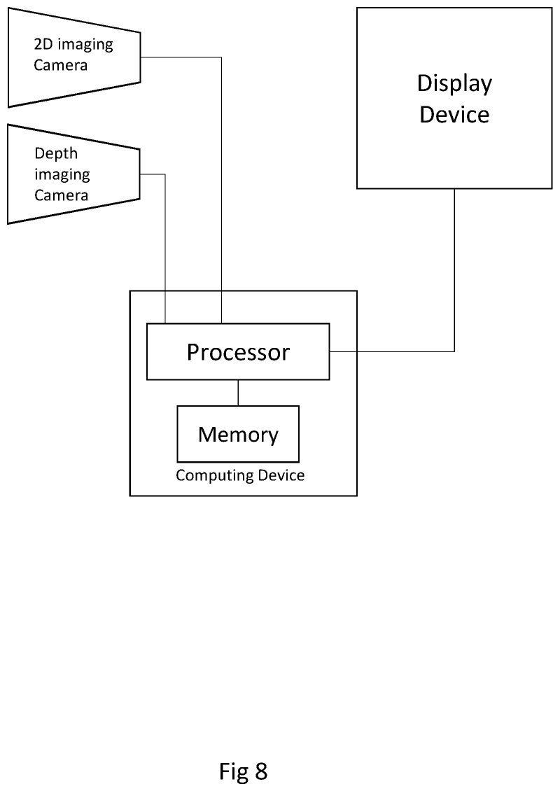

In certain embodiments (as depicted schematically in FIG. 8) a computing device comprising a processor and memory, such as a games console, is connected to a depth imaging camera device and a two-dimensional imaging camera and is also connected to a display device (for example a television or VR (virtual reality) headset). The games console has running thereon software as described above for performing the position and orientation determining process and the augmented reality process. In this way, the computing device operates as described with reference to FIG. 1 to generate position and orientation data which is then used to generate graphical elements for display on the display device in accordance with the techniques described with reference to FIGS. 3a to 3d, FIGS. 4a and 4b, FIGS. 5a to 5c and FIG. 6.

As will be understood, in embodiments in which there is no requirement to capture images of the scene (for example where the position and orientation data is only used to provide control input for a game), there is no requirement for a convention two-dimensional imaging camera.

In certain embodiments described above, the three-dimensional pattern of which the markers comprise includes a grid of squares in which a certain number of squares within the grid are elevated above the object surface a predetermined amount. However, any suitable three-dimensional pattern can be used for the markers. For example, the markers need not be rectangular, or grid based, they can be any suitable kind of manufactured three-dimensional patterns, for example bumps, notches, ridges, and so on. In certain embodiments, the three-dimensional patterns can comprise elements which are indented in the object surface instead of, or as well as elements which project above the object surface.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A method of tracking an object comprising:
imaging a marker on an object surface using a depth imaging camera, said marker comprising a three-dimensional pattern;
generating a representation of the marker;
matching the representation of the marker to a representation of a reference three-dimensional pattern in a reference orientation;
comparing the representation of the marker to the representation of the reference three-dimensional pattern, and thereby
determining a position and orientation of the object relative to the camera.

2. A method of tracking an object according to claim 1, further comprising
generating and displaying on a display a graphical element in dependence on the determined position and orientation of the object.

3. A method according to claim 2, wherein generating and displaying on the display the graphical element in dependence on the determined position and orientation of the object, comprises displaying one or more of a position, size and orientation of the graphical element on the display in dependence on the determined position and orientation of the object.

4. A method according to claim 2, comprising
capturing images of a scene including the object with a two-dimensional camera, and
displaying the images of the scene on the display.

5. A method according to claim 4, comprising displaying the graphical element on the display in a position corresponding to the position of the object in the scene, thereby superimposing the graphical element over the object in the image of the scene.

6. A method according to claim 2, wherein the graphical element is a representation of a three-dimensional object.

7. A method according to claim 2, wherein the marker is one of a plurality of markers, said method comprising
identifying to which marker from the plurality of markers the marker on the object surface corresponds.

8. A method according to claim 7, wherein each of the plurality of markers is associated with an object, said method further comprising
identifying the object based on the identification of the marker from the plurality of markers.

9. A method according to claim 7, wherein the graphical element is one of a plurality of graphical elements, said method further comprising, responsive to identifying which marker from the plurality of markers the marker on the object surface corresponds,
selecting the graphical element from the plurality of graphical elements.

10. A method according to claim 1, comprising imaging one or more further markers on the object surface using the depth imaging camera, said further markers comprising a three-dimensional pattern;
generating a representation of each of the further markers;
matching the representations of the further markers to a representation of a reference three-dimensional pattern in a reference orientation;
comparing the representations of the further markers to the representation of the reference three-dimensional pattern, and thereby
further determining a position and orientation of the object relative to the camera.

11. A method according to claim 10, comprising
identifying on the marker and the one or more further markers an identifying mark uniquely identifying that marker, and
determining a position of the marker and one or more further markers on the surface of the object based on the identifying mark on each of the marker and one or more further markers.

12. A method according to claim 1, wherein the marker is a three-dimensional grid comprising grid elements, wherein one or more of the grid elements are raised grid elements.

13. A method according to claim 2, wherein the display is a display of a user device.

14. An object tracking system comprising a depth imaging camera, a processor and a memory adapted to perform a method according to claim 1.

15. An object tracking system according to claim 14, wherein the object tracking device is provided by a user device.

16. An object tracking system according to claim 15, wherein the user device is a smartphone.

17. A computer program comprising computer implementable instructions which when implemented on a processor of an object tracking device controls the processor to perform a method according to claim 1.
